(19) United States
(12) Patent Application Publication
(10) Pub. No.: US 2025/0093072 A1
(43) Pub. Date: Mar. 20, 2025

(54) HEATING ASSEMBLY

(71) Applicant: B/E Aerospace, Inc., Winston Salem, NC (US)

(72) Inventors: Arnau Castillo, Maarssen (NL); Manuel Perez Camacho, Nieuwegein (NL); Frederik Adrian Stephan Panjer, Maarsbergen (NL); Mudar Abu-Saymeh, Olathe, KS (US); Brian Mills, Blue Springs, MO (US)

(73) Assignee: B/E Aerospace, Inc., Winston Salem, NC (US)

(21) Appl. No.: 18/820,943

(22) Filed: Aug. 30, 2024

(30) Foreign Application Priority Data
Sep. 18, 2023 (EP) 23198062.4

(51) Int. Cl. F24H 1/00; H05B 6/80

(52) U.S. Cl. CPC F24H 1/009; H05B 6/804; F24H 2250/12

(57) ABSTRACT

A heating assembly for a vehicle, the heating assembly comprising: a fluid conduit for carrying fluid; a heater positioned along the fluid conduit, the heater comprising a heating element configured to heat any fluid within the fluid conduit and a power source configured to supply power to the heating element; and a heat sink positioned upstream of the heating element and thermally coupling the power source to the fluid conduit, such that the fluid receives heat from the power source in use.

### CROSS-REFERENCE TO RELATED APPLICATIONS

This application claims priority to EP Patent Application No. 23198062.4, filed Sep. 18, 2023 and titled “HEATING ASSEMBLY,” which is incorporated by reference herein in its entirety for all purposes.

### FIELD

The present disclosure relates to a heating assembly in an aircraft.

### BACKGROUND

Traditional methods for heating liquids in an aircraft, for example heating water in galley inserts or lavatories, involves the heating of entire tanks of water. These tanks take up precious and valuable space within the aircraft or aircraft cabin which could be used for alternative features.

### SUMMARY

In an aspect, a heating assembly for a vehicle is provided. The heating assembly comprises a fluid conduit for carrying fluid, a heater positioned along the fluid conduit, the heater comprising a heating element configured to heat any fluid within the fluid conduit and a power source configured to supply power to the heating element, and a heat sink positioned upstream of the heating element and thermally coupling the power source to the fluid conduit, such that the fluid receives heat from the power source in use.

The fluid conduit may extend through at least a portion of the heat sink. The fluid conduit may comprise a tortuous path positioned within the heat sink. The heating element may be configured to emit radiation towards the fluid conduit to heat any fluid in the conduit. The heater may comprise a signal generator configured to generate a radio frequency signal, for example, a microwave signal. The power source may be a power amplifier. The power amplifier may be configured to amplify the generated radio frequency signal. The power amplifier may be configured to transmit the amplified signal to the heating element. The power amplifier may be directly adjacent to the heating element. The heating element may comprise an antenna configured to emit radiation towards the fluid conduit to heat any fluid in the fluid conduit. The heating element may comprise a capacitive coupling electrode configured to induce an alternating electric field to heat any fluid in the fluid conduit. The fluid may be water.

The heating assembly may further comprise one or more further heaters positioned along the fluid conduit, the or each further heater comprising a further heating element configured to heat any fluid within the fluid conduit and a further power source configured to supply power to the further heating element, and a further heat sink positioned upstream of the further heating element and thermally coupling the further power source to the fluid conduit.

The heat sink and the further heat sink may be formed as a combined heat sink thermally coupling the power source and the further power source to the fluid conduit.

The further heater may have the same construction as the heater. The further heater and the heater may be arranged on opposite points on the fluid conduit such that substantially the same portion of fluid in the fluid conduit can be heated by both the further heater and the heater. The heater may be a Solid State Radio Frequency heater.

In yet another aspect, an aircraft is provided. The aircraft comprises a reservoir of fluid, and any of the above-described heating assemblies. The heating assembly may be further configured to receive, by the fluid conduit, fluid from the reservoir, heat, by the heater, the received fluid, and output the heated fluid.

The aircraft may further comprise a lavatory or beverage maker coupled to the heating assembly and configured to receive the outputted heated fluid.

In yet another aspect, a method of heating a fluid in a vehicle is provided. The method comprises flowing the fluid through a fluid conduit, supplying power, by a power source, to a heater, and heating, by a heater and using the supplied power, the fluid in the fluid conduit. A heat sink thermally couples the power source to the fluid conduit upstream of the heater.

### BRIEF DESCRIPTION OF THE DRAWINGS

FIG. 1 shows a perspective view (not to scale) of a heating assembly; and

FIG. 2 shows a cross-sectional view (not to scale) of a heat sink of a heating assembly.

### DETAILED DESCRIPTION

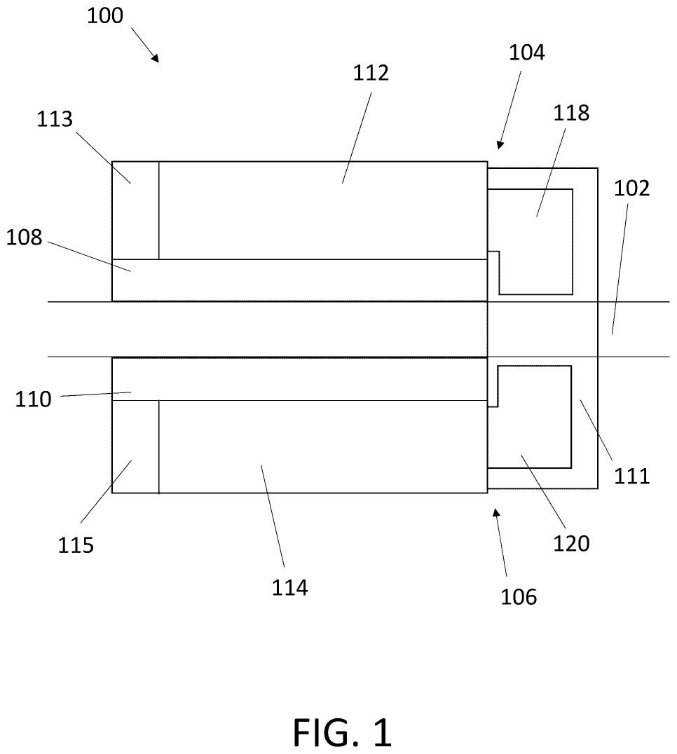

FIG. 1 shows a perspective view of a heating assembly 100 of a vehicle (not shown), such as an aircraft. The heating assembly 100 comprises a fluid conduit 102, a first heater 104, a second heater 106, a first heat sink 108, and a second heat sink 110, a compartment 111, a first power source 112, and the second power source 114. The fluid conduit 102 is configured to carry fluid to one or more consumer devices, such as a beverage maker or a lavatory. The fluid conduit 102 is positioned between the first and second heaters 104, 106. The fluid conduit 102 may be considered to be thermally coupled to the first heater 104 and/or second heaters 106. The fluid conduit 102 is arranged to be in contact with and/or to abut the first and second heater 104, 106. In this embodiment, the fluid conduit may carry water to a beverage maker or a lavatory. In other embodiments, the fluid conduit may be used in applications other than for carrying water to a beverage maker or a lavatory, for example, the fluid conduit may carry air for an environmental system such as an air conditioning unit. In other embodiments, the fluid conduit may carry air, or any other gas, or a liquid other than water. In some embodiments, the fluid may be oil for lubrication.

In this embodiment, the first heater 104 comprises the first power source 112, first signal generator 113, and a first antenna 118. The first signal generator 113 is configured to generate radio frequency signals, e.g. microwave signals. The first power source 112 is configured to supply power to the first antenna 118. The first power source 112 may be a first power amplifier 112 that is communicatively coupled to the first signal generator 113 to receive the generated signal and amplify that signal. The first power amplifier 112 is also coupled to the first antenna 118. The first power amplifier 112 is also configured to send the amplified signal to the first antenna 118. The first antenna 118 is configured to receive the amplified signal. The first antenna 118 is also configured to emit radiation, e.g. microwaves, towards the fluid conduit to heat any fluid within the fluid conduit 102. The emitted radiation may be based on the amplified signal received from the first power amplifier 112 and/or generated by the signal generator 113. The first antenna 118 may convert the amplified signal into emissions of electromagnetic radiation, e.g. microwaves. In other words, the signal generated by the first signal generator 113 may be emitted into the fluid by means of the first antenna 118 and/or the first power amplifier 112. The signal generated by the first signal generator 113 may be considered to be an electrical signal corresponding to the electromagnetic radiation emitted by the antenna. In some embodiments, the electric signal may correspond to an electromagnetic field created by the heating element, e.g. the first antenna 118. For example, the electrical signal may have the same frequency as the electromagnetic radiation emitted by the antenna. In this way, the first heater 104 may be considered to be a Solid State Radio Frequency (SSRF) heater configured to heat the fluid flowing through the fluid conduit 102. In other embodiments, the first heater is not a SSRF heater, e.g. the first heater may be any heating system other than a SSRF heater.

The first power source 112 is positioned upstream of the first antenna 118 along the fluid conduit 102.

In this embodiment, the first antenna is directly adjacent to the first power source to minimize the space between the first antenna and the first power source. In this arrangement, the first antenna may be considered to be the directly connected to the first power source. Advantageously, connection cables between the first antenna and the first power source tend to be minimized thereby reducing weight, and/or required space, and/or cost, and/or power losses, which are particularly important in an airplane setting. In other embodiments, the first antenna is not directly connected to the first power source to minimize the space between the first antenna and the first power source. In this embodiment, the first heater comprises a first heating element that is a first antenna. In other embodiments, the first heater comprises a first heating element that is not a first antenna, e.g. the first heating element comprises a capacitive coupling electrode configured to induce an alternating electric field. The capacitive coupling electrode can transfer energy directly to the fluid by capacitive coupling. Specifically, an alternating voltage is applied between, at least, two electrodes. The polar molecules contained in the material (i.e. water molecules) will align themselves with the applied electromagnetic field. As such, as the electric field from the alternative voltage alternates/switches, the polar molecules in attempting to align themselves with the alternating field will collide with and/or rub against the other molecules in the material. The friction arising from such collisions and rubbing movements tend to raise the temperature of the material.

The heating assembly 100 further comprises a first heat sink 108 that thermally couples the first power source 112 to the fluid conduit 102. The first heat sink 108 is positioned between the first power source 112 and the fluid conduit 102. The first heat sink 108 is positioned upstream of the first antenna 118 and/or the first heater 104. In this way, the first heat sink 108 can draw heat away from the first power source 112 and transfer that heat to the fluid conduit 102 and/or the fluid flowing within the fluid conduit 102.

In this embodiment, the first heat sink abuts and/or directly contacts the first power source. In other embodiments, the first heat sink does not abut or directly contacts the first power source, e.g. the first heat sink abuts and/or contacts the first antenna or the first heat sink is spaced apart from the power source or the antenna. In this embodiment, the first heat sink abuts and/or directly contacts the fluid conduit. In other embodiments, the first heat sink is spaced apart from the fluid conduit.

In this embodiment, the second heater 106 comprises a second antenna 120, a second power source 114, and a second signal generator 115. The second power source 114 is configured to supply power to the second antenna 120. The second signal generator 115 is configured to generate a radio frequency signal, e.g. a microwave signal. The second power source 114 may be a second power amplifier 114 that is communicatively coupled to the second signal generator 115 to receive the generated signal and amplify the received signal. The second power amplifier 114 is also coupled to the second antenna 120. The second power amplifier 114 is also configured to send the amplified signal to the second antenna 120. The second antenna 120 is configured to receive the amplified signal. The second antenna 120 is also configured to emit radiation, e.g. microwaves, towards the fluid conduit to heat any fluid in the fluid conduit. The emitted radiation may be based on the amplified signal received from the second power amplifier 114. The second antenna 120 may convert the amplified signal into emissions of electromagnetic radiation, e.g. microwaves. In other words, the signal generated by the second signal generator 115 may be emitted into the fluid by means of the second antenna 120 and/or the second power amplifier 114. The signal generated by the signal generator may be considered to be an electrical signal corresponding to the electromagnetic radiation emitted by the antenna. For example, the electrical signal may have the same frequency as the electromagnetic radiation emitted by the antenna. In this way, the second heater 106 may be considered to be a SSRF heater configured to heat the fluid within the fluid conduit 102. In other embodiments, the second heater is not a SSRF heater, e.g. the second heater may be any heating system other than a SSRF heater.

The second power source 114 is positioned upstream of the second antenna 120 along the fluid conduit 102.

In this embodiment, the second antenna is directly connected to the second power source to minimize the space between the second antenna and the second power source. This has similar advantages as those described above for the direct connection of the first antenna with the first power source. In other embodiments, the second antenna is not directly connected to the second power source to minimize the space between the second antenna and the second power source.

The heating assembly 100 further comprises a second heat sink 110 that thermally couples the second power source 114 to the fluid conduit 102. The second heat sink 110 is positioned between the second power source 114 and the fluid conduit 102. In this way, the second heat sink 110 can draw heat away from the second power source 114 and transfer that heat to the fluid conduit 102.

In this embodiment, the second heat sink abuts and/or contacts the second power source. In other embodiments, the second heat sink does not abut or contacts second the power source, e.g. the second heat sink abuts and/or contacts the antenna or the second heat sink is spaced apart from the power source and/or the antenna. In this embodiment, the second heat sink is spaced apart from the fluid conduit. In other embodiments, the second heat sink abuts and/or contacts the fluid conduit.

In some embodiments, the heat sink may be made from metal, such as aluminium, or a metal alloy.

In some embodiments, the first and/or second heaters may be a SSRF Module. A SSRF module generates and amplifies radio frequencies by means of solid-state technology (semiconductors). The radio signal may be generated via a small signal generator, i.e. a microchip. However, signals generators tend have very low energy and the radio frequency signal needs to be amplified by a radio frequency amplifier within the SSRF module. For example, the microchip and a radio frequency transistor may be part of the first and/or second heaters 104, 106. Advantageously, use of an integrated power amplifier, e.g. the first or second power amplifier 112, 114, can boost the energy of the generated signal to a more useful high energy signal. Each of the first and/or second antennas 118, 120 may be considered to be a heating element.

The compartment 111 is configured to contain the electromagnetic radiation emitted by the first and second antennas 118, 120. The compartment 111 comprises a cavity. The first and second antennas 118, 120 are positioned within the compartment 111, e.g. positioned within the cavity. The compartment 111 further comprises walls that hinder and/or prevent the propagation of electromagnetic radiation from the inside of the cavity to the outside of the cavity. The walls of the compartment are coupled to each other to define the cavity therein. The first and second antennas 118, 120 are each positioned within the compartment 111. The first and second antennas 118, 120 are each arrange to emit electromagnetic radiation inside the compartment 111.

In the above embodiments, the compartment is configured to contain the electromagnetic radiation emitted by both the first and second antennas. In other embodiments, the compartment is not configured to contain the electromagnetic radiation emitted by both the first and second antennas, e.g. the compartment is configured to contain electromagnetic radiation from only one of the first and second antennas. In some embodiments, the compartment may be considered a Faraday cage. In some embodiments, the compartment comprises an internal surface defining the cavity that is reflective to the electromagnetic radiation emitted by the first and/or second antennas. In such embodiments, the electromagnetic radiation emitted by the first and/or second antennas may form a standing wave within the cavity. In the above embodiments, the first and second antennas are positioned within the cavity. In other embodiments, the first and second antennas are not positioned within the cavity, e.g. only one of the first and second antennas is positioned within the cavity or neither of the first and second antennas are positioned within the cavity. In some embodiment, the first and/or second heaters may each have a plurality of heating elements such as antennas.

In this embodiment, the heating assembly comprises the first and second heaters. In other embodiments, the heating assembly does not comprise the first and second heaters, e.g. the heating assembly may comprise only one heater or the heating assembly may comprise more than two heaters. In some embodiments, there may be a plurality of heaters positioned about and/or around the fluid conduit. In this embodiment, the first and second heaters are both a SSRF heaters. In other embodiments, the first and second heaters are not both a SSRF heaters, e.g. only one of the first and second heaters is a SSRF heater or the first and/or second heaters may be a heater other than a SSRFM module. In this embodiment, the first and second heaters are positioned at the same point along the fluid conduit. In other embodiments, the first and second heaters are not positioned at the same point along the fluid conduit, e.g. the first and second heaters are positioned at different points along the fluid conduit. In this embodiment, the first and second heaters are positioned on opposite sides of the fluid conduit. In other embodiments, the first and second heaters are not positioned on opposite sides of the fluid conduit, e.g. the first and second heaters are positioned on adjacent sides of the fluid conduit.

In this embodiment, the first and second antennas are each arranged to emit radiation and/or transfer energy to the same point along the fluid conduit. In other words, the first and second antennas are arranged such that substantially the same portion of fluid in the fluid conduit can be heated by both the first and second antennas. Advantageously, this improves the speed in which the fluid in the fluid conduit may be heated. For example, this may be due to the synergistic superposition of the microwaves emitted from the first and second antennas. In other embodiments, the first and second antennas may be each arranged to emit radiation and/or transfer energy to different points along the fluid conduit.

Solid State Radio Frequency (SSRF) modules can be used instead of conventional heating devices to heat fluids, such as water, in aircraft. However, the tendency with SSRF modules is to get extremely hot during use, which may cause thermal energy to be lost and external cooling systems to be required.

Advantageously, the heat sink (i.e. the first and/or second heat sinks) can simultaneously cool the heater whilst pre-heating the fluid to be heated before that fluid reaches the heating element, e.g. the first or second antenna. This means that less energy is needed for heating by the heating element thereby reducing power consumption. Moreover, external cooling systems also tend to be reduced and/or eliminated further reducing power consumption. This means that the overall power used in the heating process is much reduced. Moreover, the wasted heat, e.g. in supplying power to the antenna or in amplifying the radio frequency, is recycled/used, e.g. to pre-heat the fluid, meaning that less power is actually wasted. In other words, the power is used much more efficiently in the above-described heating assemblies when compared to conventional systems. Indeed, it was surprisingly found that the biggest producer of heat is the power amplifier, e.g. a radio frequency transistor. Furthermore, the lack of external cooling systems means that the heating assembly is more compact and takes up less space. Power consumption, efficiency, and volume of equipment are particularly important aspects in aerospace which may not be fully appreciated or considered from other fields, such as electronics in general.

Additionally, the lack of external cooling systems also means that there are fewer components that can fail and/or degrade. As such, maintenance tends to be reduced for the above-described heating assemblies. Moreover, by linking the pre-heating process with the cooling process this creates a self-consistent feedback loop. This means that external monitoring and/or control systems are also not required. For example, when the heaters are operating intensively, this may produce large amounts of excess heat. This in turn means that the fluids are pre-heated to a higher temperature which results in a reduced work load for the heaters. Since external monitoring and/or controlling systems also tend to be reduced or eliminated, this further reduces the space requirements for such a heating assembly.

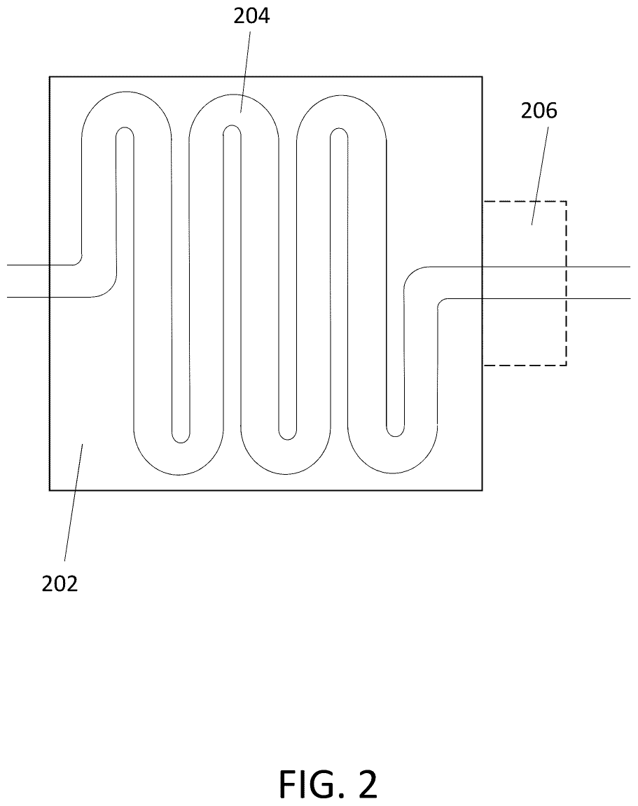

FIG. 2 shows a cross-sectional view of a heat sink 202 in an alternative heating assembly. The alternative heating assembly is the same as the heating assembly described above except that there is only one heat sink 202 and the fluid conduit 204 is positioned within that one heat sink 202. Advantageously, the fluid conduit 204 being positioned within the heat sink 202 means that there is improve contact with the heat sink 202, e.g. when compared with the embodiment shown in FIG. 1. As such, heat transfer rate is improved in such a set up.

The heat sink 202 abuts and/or contacts the first and second power sources (not shown in FIG. 2). For example, the heat sink 202 may abut and/or contact the first and second power amplifiers. The heat sink 202 is therefore a combined heat sink, thermally coupling the first and second power sources to the fluid conduit 204. A combined heat sink may be considered to be a single continuous heat sink. The heat sink 202 has a generally planar shape with the first power amplifier abutting and/or contacting one of the planar surfaces and the second power amplifier abutting and/or contacting the other planar surface.

The fluid conduit 204 has a tortuous path within the heat sink 202. In other words, the fluid conduit 204 has a snaking and/or convoluted and/or serpentine path within the heat sink 202. The fluid conduit 204 at the exit of the heat sink 202 can be heated by at least one heater 206 (shown in phantom). The heater 206 may be any of the above-described heaters.

Advantageously, the tortuous nature of the fluid conduit tends to increase the heat transfer surface and/or time for heat transfer between the fluid to be heated and the heat sink 202. This in turn improves the amount of heat transferred between the heat sink 202 and the fluid conduit 204, thereby increasing the amount of pre-heating achieved. As such, efficiency tends to be further improved by such a set up.

In this embodiment, there is only one heat sink. In other embodiments, there is a plurality of heat sinks. In this embodiment, the tortuous portion of the fluid conduit is positioned within the heat sink. In other embodiment, the tortuous portion of the fluid conduit is not positioned within the heat sink.

Various aspects of the heating assembly disclosed in the various embodiments may be used alone, in combination, or in a variety of arrangements not specifically discussed in the embodiments described in the foregoing and this disclosure is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A heating assembly for a vehicle, the heating assembly comprising:
a fluid conduit for carrying fluid;
a heater positioned along the fluid conduit, the heater comprising a heating element configured to heat any fluid within the fluid conduit and a power source configured to supply power to the heating element; and
a heat sink positioned upstream of the heating element and thermally coupling the power source to the fluid conduit, such that the fluid receives heat from the power source in use.

2. The heating assembly of claim 1, wherein the fluid conduit extends through at least a portion of the heat sink.

3. The heating assembly of claim 1, wherein the fluid conduit comprises a tortuous path positioned within the heat sink.

4. The heating assembly of claim 1, wherein the heating element is configured to emit radiation towards the fluid conduit to heat any fluid in the conduit.

5. The heating assembly of claim 4, wherein:
the heater comprises a signal generator configured to generate a radio frequency signal; and
the power source is a power amplifier configured to amplify the generated radio frequency signal and transmit the amplified signal to the heating element.

6. The heating assembly of claim 5, wherein the power amplifier is directly adjacent to the heating element.

7. The heating assembly of claim 1, wherein the heating element comprises an antenna configured to emit radiation towards the fluid conduit to heat any fluid in the fluid conduit.

8. The heating assembly of claim 1, wherein the heating element comprises a capacitive coupling electrode configured to induce an alternating electric field to heat any fluid in the fluid conduit.

9. The heating assembly of claim 1, where the fluid is water.

10. The heating assembly of claim 1, further comprising:
one or more further heaters positioned along the fluid conduit, the or each further heater comprising a further heating element configured to heat any fluid within the fluid conduit and a further power source configured to supply power to the further heating element; and
a further heat sink positioned upstream of the further heating element and thermally coupling the further power source to the fluid conduit.

11. The heating assembly of claim 10, wherein the heat sink and the further heat sink are formed as a combined heat sink thermally coupling the power source and the further power source to the fluid conduit.

12. The heating assembly of claim 10, wherein the further heater and the heater are arranged on opposite points on the fluid conduit such that substantially the same portion of fluid in the fluid conduit can be heated by both the further heater and the heater.

13. The heating assembly of claim 1, wherein the heater is a Solid State Radio Frequency heater.

14. An aircraft comprising:
a reservoir of fluid; and
the heating assembly of claim 1, the heating assembly is further configured to:
receive, by the fluid conduit, fluid from the reservoir, heat, by the heater, the received fluid, and
output the heated fluid;
more preferably the aircraft further comprises a lavatory or beverage maker coupled to the heating assembly and configured to receive the outputted heated fluid.

15. A method of heating a fluid in a vehicle, the method comprising:
flowing the fluid through a fluid conduit;
supplying power, by a power source, to a heater; and
heating, by a heater and using the supplied power, the fluid in the fluid conduit;
wherein a heat sink thermally couples the power source to the fluid conduit upstream of the heater.
